(19) United States
(12) Patent Application Publication
(10) Pub. No.: US 2010/0110498 A1
(43) Pub. Date: May 6, 2010

(54) PRINTING APPARATUS AND CONTROL METHOD THEREOF

(75) Inventor: Tsutomu Sakaue, Yokohama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/582,832

(22) Filed: Oct. 21, 2009

(30) Foreign Application Priority Data
Oct. 30, 2008 (JP) 2008-280273

(51) Int. Cl. H04N 1/40

(52) U.S. Cl. 358/3.28

(57) ABSTRACT

In order to provide a technique that allows to print out a CFIP composite image with an appropriate image density, a printing apparatus includes a storage unit which stores CFIP image data including a latent portion and background portion, a comparison unit which compares a CFIP density setting value at the generation timing of the CFIP image data and that at the issuance timing of the printout instruction, a replacement unit which replaces, when the comparison unit determines that the CFIP density setting values are not equal to each other, an image pattern of at least one of the latent and background portions included in the CFIP image data by the other image pattern having a different density, and a control unit which prints out the CFIP image data in which the image pattern of at least one of the latent and background portions is replaced.

### BACKGROUND OF THE INVENTION

1. Field of the Invention

The present invention relates to a printing apparatus and control method thereof and, more particularly, to an image density adjustment technique upon printing out a copy-forgery-inhibited pattern image (to be abbreviated as a CFIP image hereinafter).

2. Description of the Related Art

On some original documents of receipts, securities, and certificates, a special pattern that emerges as a predetermined character string when they are copied is printed on a background. This special pattern is generally called a “CFIP image”. This CFIP image psychologically warns against copying, or can suppress use of a copy even when an original document is copied.

This CFIP image is basically formed of two regions, that is, a region where dots remain after copying (latent portion) and a region where dots disappear after copying (background portion). These two regions have nearly equal reflection densities on an original document. Concentrated large dots are laid out on the latent portion, and scattered small dots are laid out on the background portion. Note that the scattered small dots have a size that is too small to be reproduced by a general copying machine (for example, about 42 μm×42 μm). On the other hand, the concentrated large dots have a size which can be reproduced by a general copying machine (for example, about 84 μm×84 μm).

For this reason, when an original document printed with a CFIP image is copied, only the latent portion where large dots are laid out is reproduced on that copy. Note that if the latent portion has a shape of a certain character string, a predetermined character string seemingly emerges on the copy.

The concentrated large dots and scattered small dots are generated by dithering using different dither matrices. For example, Japanese Patent Laid-Open No. 2001-197297 (patent reference 1) discloses that a dot-concentrated dither matrix is used to obtain a concentrated dot layout, and a dot-scattered dither matrix is used to obtain a scattered dot layout.

An image processing apparatus performs density adjustment of a CFIP image, so as to set nearly equal reflection densities of latent and background portions on an original document. Japanese Patent Laid-Open No. 2005-091730 (patent reference 2) discloses a technique for generating a plurality of patch data in which the density value of an image of the latent portion is set to be a predetermined value, and the density value of an image of the background portion is changed step by step. Then, the generated patch data are formed on a sheet. The user finds out a patch in which the reflection density of the image of the latent portion is nearly equal to that of the image of the background portion, and selects the number of the found patch from a UI. Then, upon execution of the next or subsequent CFIP print processing, a CFIP image is generated using the reflection densities used upon generating the patch of the selected number.

Furthermore, Japanese Patent Laid-Open No. 2007-129694 (patent reference 3) discloses a technique for prompting the user to use a CFIP image density adjustment technique so as to generate a stable CFIP image. Even when the density adjustment of a CFIP image is executed in the technique disclosed in patent reference 2, that density adjustment result is not always appropriate after an elapse of a certain period of time. For this reason, in patent reference 3, the measured density value of an image processing apparatus at the current timing is compared with that at the CFIP image density adjustment timing, and a variation amount of the output density of the image processing apparatus from the CFIP image density adjustment timing until the current timing is calculated. Then, it is determined if the calculated density variation amount exceeds an effective density range (density variation amount threshold) as a CFIP image. If the density variation amount threshold is exceeded, the user is notified that the density of a CFIP image may become an inappropriate density as the CFIP image due to a density variation. As a result, the user can confirm whether or not an existing CFIP image is appropriate.

However, the aforementioned technique is effective when a new CFIP image is generated, but it often cannot obtain a sufficient effect when an already generated CFIP image is output. For example, when a CFIP image is output after an elapse of a certain time since it was generated, the output CFIP image may often suffer troubles. This is because even when a CFIP image was generated to have an optimally adjusted density, if the generation timing and output timing have a certain time difference, the density of a CFIP image at the output timing has changed due to variations of the print characteristics of the image processing apparatus.

For example, when the density of the background portion of a CFIP image stored in the image processing apparatus is raised, and that CFIP image is output, a background image does not disappear, and the latent portion cannot be visualized when an output matter of the CFIP image is copied. That is, the psychological deterrent force against copying due to visualization of a latent image upon copying an output matter of a CFIP image is lost.

The present invention provides a technique which allows printing out a CFIP composite image with an appropriate image density without losing any CFIP function.

### SUMMARY OF THE INVENTION

According to one aspect of the present invention, a printing apparatus comprises: a storage unit which stores copy-forgery-inhibited pattern (CFIP) image data including a latent portion and a background portion; a comparison unit which compares, when a printout instruction of the CFIP image data stored in the storage unit is issued, a CFIP density setting value at a generation timing of the CFIP image data and a CFIP density setting value at an issuance timing of the printout instruction; a replacement unit which replaces, when the comparison unit determines that the CFIP density setting values are not equal to each other, an image pattern of at least one of the latent portion and the background portion included in the CFIP image data by the other image pattern having a different density; and a control unit which controls an image forming unit to print out the CFIP image data in which the image pattern of at least one of the latent portion and the background portion is replaced.

According to another aspect of the present invention, a method of controlling a printing apparatus, comprises the steps of: storing, in a storage unit, copy-forgery-inhibited pattern (CFIP) image data including a latent portion and a background portion; comparing, when a printout instruction of the CFIP image data stored in the storage unit is issued, a CFIP density setting value at a generation timing of the CFIP image data and a CFIP density setting value at an issuance timing of the printout instruction; replacing, when it is determined in the comparing step that the CFIP density setting values are not equal to each other, an image pattern of at least one of the latent portion and the background portion included in the CFIP image data by the other image pattern having a different density; and controlling an image forming unit to print out the CFIP image data in which the image pattern of at least one of the latent portion and the background portion is replaced.

According to the present invention, a technique which allows printing out a CFIP composite image with an appropriate image density without losing any CFIP function can be provided.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the hardware arrangement of a printing apparatus according to the first embodiment;

FIG. 2 is a flowchart showing the processing of a CFIP image generation unit of the printing apparatus according to the first embodiment;

FIG. 3 is a view showing an example of a spiral (concentrated) dither matrix;

FIG. 4 is a view showing examples of threshold patterns using the spiral dither matrix;

FIG. 5 is a view showing an example of a Bayer dither matrix;

FIG. 6 is a view showing examples of threshold patterns using the Bayer dither matrix;

FIG. 7 is a view showing an example of a CFIP image;

FIG. 8 is a block diagram showing a density adjustment method of a CFIP image;

FIG. 9 is a view showing an example of patches used in the density adjustment method of a CFIP image;

FIG. 10 is a block diagram showing the hardware arrangement of a printing apparatus which includes a density adjustment mechanism;

FIG. 11 is a flowchart showing the density adjustment method of a CFIP image;

FIG. 12 is a block diagram showing the arrangement of density correction of a document image;

FIG. 13 is a diagram showing the arrangement of a density correction unit used in density correction of a document image;

FIG. 14 is a view showing density patches used in density correction of a document image;

FIG. 15 is a graph showing the density characteristics of a printer to which density correction of a document image is to be applied;

FIG. 16 is a graph showing the density correction characteristics of a printer to which density correction of a document image is to be applied;

FIG. 17 is a view showing a practical example of the patches shown in FIG. 9;

FIG. 18 is a view showing the effect of a CFIP function;

FIG. 19 is a view showing an example in which the background density is raised and the effect of the CFIP function is insufficient;

FIG. 20 is a view showing a CFIP density adjustment method;

FIG. 21 is a view showing a CFIP density adjustment method;

FIG. 22 is a flowchart showing a CFIP density adjustment method according to the first embodiment;

FIG. 23 is a flowchart showing a CFIP density adjustment method according to the first modification;

FIG. 24 is a flowchart showing a CFIP density adjustment method according to the second modification;

FIGS. 25A and 25B are flowcharts showing a CFIP density adjustment method according to the third modification;

FIG. 26 is a flowchart showing a CFIP density adjustment method according to the fourth modification;

FIG. 27 is a flowchart showing a CFIP density adjustment method according to the second embodiment;

FIG. 28 is a flowchart showing a CFIP density adjustment method according to the third embodiment; and

FIG. 29 is a flowchart showing a CFIP pattern detection method of the printing apparatus according to the first embodiment.

### DESCRIPTION OF THE EMBODIMENTS

Preferred embodiments of the present invention will be described in detail hereinafter with reference to the drawings. Note that the following embodiments are merely examples, and do not limit the scope of the present invention.

### First Embodiment

As the first embodiment of an image processing apparatus according to the present invention, a printing apparatus which composites and prints a CFIP image will be exemplified below.

<Description of CFIP Image>

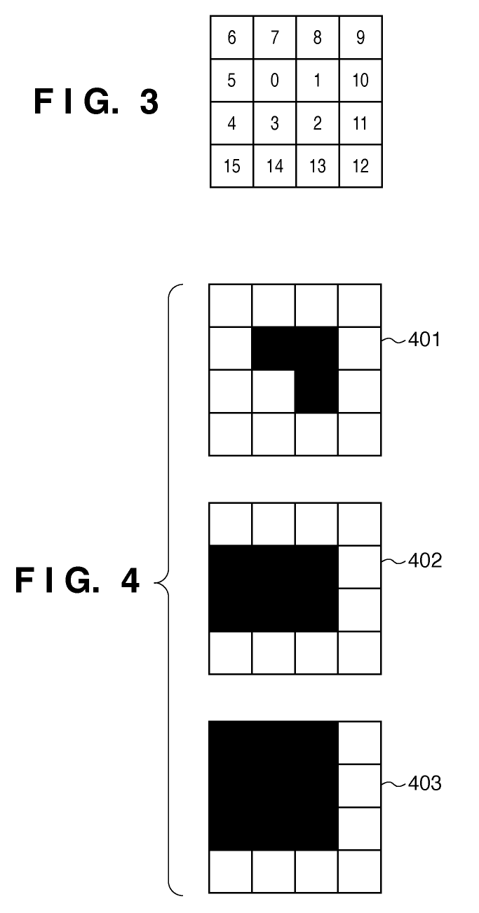

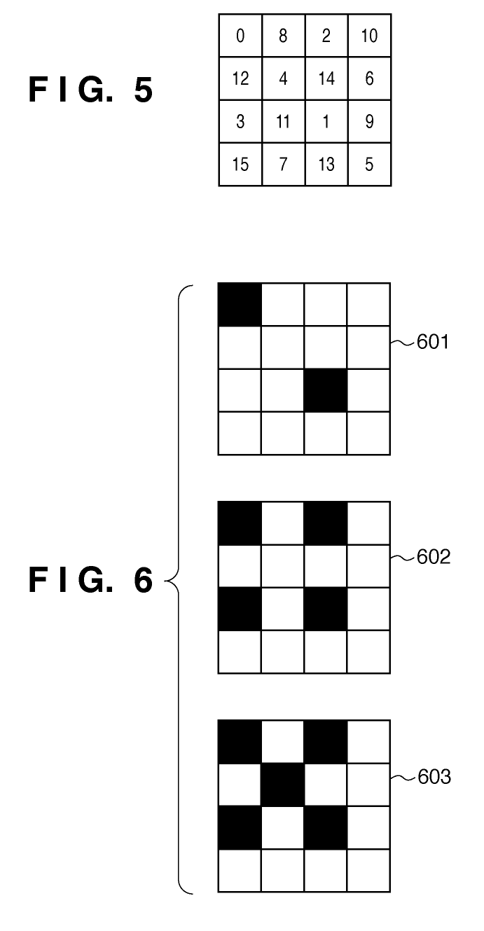

A CFIP image is formed of a latent portion and background portion. An image corresponding to the latent portion is designed so that dots are laid out at concentrated positions using a dot-concentrated dither matrix. An image corresponding to the background portion is designed so that dots are laid out at scattered positions using a dot-scattered dither matrix. The dither matrix used to generate the image of the latent portion will be referred to as a latent dither matrix, and the dither matrix used to generate the image of the background portion will be referred to as a background dither matrix. Note that a concentrated dither matrix shown in FIG. 3 is used as the latent dither matrix, and a scattered dither matrix shown in FIG. 5 is used as the background dither matrix. These dither matrices include sub-matrices, and have different spatial frequency characteristics.

In the following description, a binary image of 4 pixels×4 pixels which forms the latent portion will be referred to as a latent threshold pattern, and a binary image of 4 pixels×4 pixels which forms the background portion will be referred to as a background threshold pattern. An example of the latent threshold pattern is a pattern 401 in FIG. 4, and that of the background threshold pattern is a pattern 601 shown in FIG. 6. In this embodiment, combinations of the latent and background threshold patterns are set in advance so that latent and background portions have an equal reflection density when they are printed. That is, a pattern which includes three black pixels of 4 pixels×4 pixels is defined in advance as the latent threshold pattern (see the pattern 401 in FIG. 4), and a pattern which includes two black pixels of 4 pixels×4 pixels is defined in advance as the background threshold pattern (see the pattern 601 in FIG. 6).

A dot layout method in the latent and background portions will be described in more detail below. In the first embodiment, an image pattern of the latent portion is generated based on the dot-concentrated dither matrix, and that of the background portion is generated based on the dot-scattered dither matrix.

As a typical dot-concentrated dither matrix used to generate the latent portion, a spiral dither matrix is known.

FIG. 3 is a view showing an example of a 4×4 concentrated dither matrix. Numerical values in respective dots in FIG. 3 represent thresholds of the concentrated dither matrix, and are laid out so that they spirally increase from the center.

FIG. 4 is a view showing latent threshold patterns (dot layouts) obtained by applying threshold processing to predetermined density values using the 4×4 concentrated dither matrix shown in FIG. 3. In FIG. 4, reference numerals 401, 402, and 403 denote threshold patterns obtained by applying the threshold processing to density values “3”, “6”, and “9” by the dither matrix shown in FIG. 3. The obtained latent threshold patterns (dot layouts) are defined by respective dots laid out at concentrated positions.

On the other hand, as a typical dot-scattered dither matrix used to form the background portion, a Bayer dither matrix is known.

FIG. 5 is a view showing an example of a 4×4 scattered dither matrix. Numerical values in respective dots in FIG. 5 represent thresholds of the scattered dither matrix. In a threshold pattern, dots are laid out at scattered positions by executing dithering using the Bayer dither matrix.

FIG. 6 is a view showing background threshold patterns (dot layouts) obtained by applying threshold processing to predetermined density values using the 4×4 scattered dither matrix shown in FIG. 5. In FIG. 6, reference numerals 601, 602, and 603 denote threshold patterns obtained by applying the threshold processing to density values “2”, “4”, and “5” by the dither matrix shown in FIG. 5. The obtained threshold patterns (dot layouts) are defined by respective dots laid out at scattered positions. In the Bayer dither matrix, elements of the threshold matrix are laid out in turn at positions where they do not contact each other as much as possible, and its threshold pattern assumes an isolated grid-like dot layout.

The first embodiment will mainly explain a case in which the Bayer dither matrix is used as the background dither matrix. However, other dot-scattered dither matrices may be used.

As described above, when the dot-concentrated dither matrix is used, concentrated large dots are generated. Such dot-concentrated pattern is generally insusceptible to print characteristic variations of a printer, large dots are formed intact on a sheet.

On the other hand, when the dot-scattered dither matrix is used, groups of isolated dots are generated. Small dots as such isolated dots are generally susceptible to the print characteristic variations of a printer compared to the aforementioned large dots, and are not always stably formed on a sheet.

For this reason, a CFIP image is normally generated by setting the number of black pixels in the background threshold pattern to be larger than that in the latent threshold pattern. Also, since a CFIP image includes small dots, the density adjustment of the CFIP image has to be frequently executed using, for example, the technique of patent reference 2.

Note that in the description of the first embodiment, the dither matrix size of each of the background and latent threshold patterns is defined by 4 pixels×4 pixels. However, the dither matrix size is not limited to such specific size, and other sizes such as 8 pixels×8 pixels and 16 pixels×16 pixels may be used.

<Basic Apparatus Arrangement>

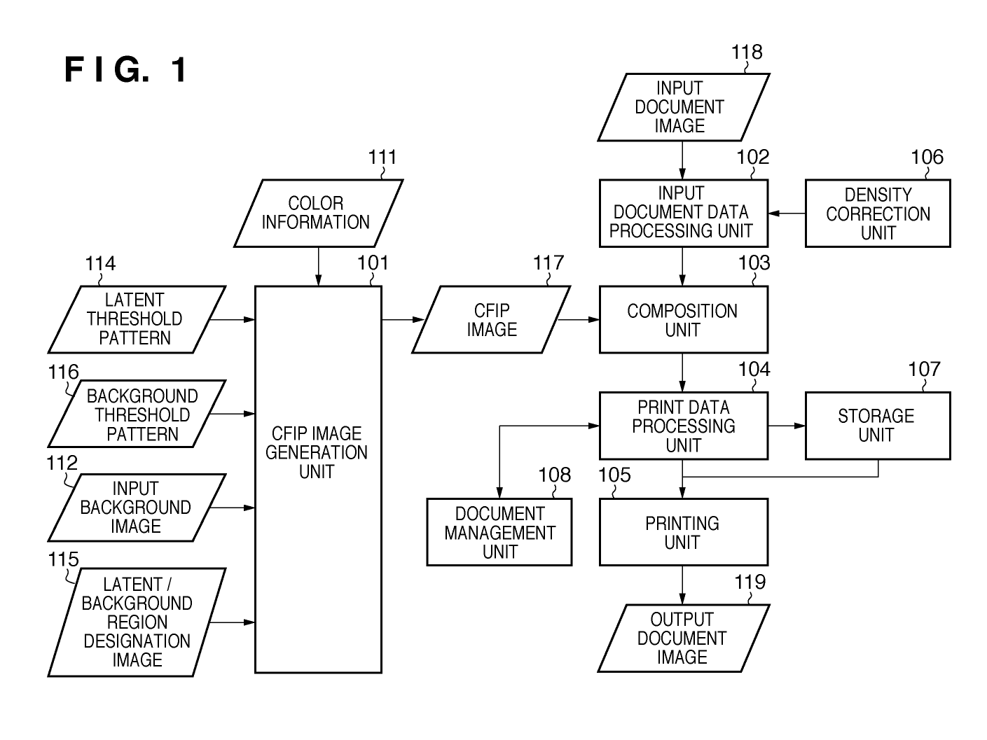

FIG. 1 is a block diagram showing the internal arrangement of a printing apparatus according to the first embodiment.

A printing apparatus 100 includes, as principal functional units, a CFIP image generation unit 101, input document data processing unit 102, composition unit 103, print data processing unit 104, printing unit 105, density correction unit 106, storage unit 107, and document management unit 108. Also, the printing apparatus 100 includes a control unit which comprehensively controls these units, and a timer which manages time.

The CFIP image generation unit 101 receives an input background image 112, latent threshold pattern 114, latent/background region designation image 115, and background threshold pattern 116. The latent/background region designation image 115 is used to designate regions of latent and background portions, and includes 1 bit per pixel. For example, one bit “0” of the latent/background region designation image 115 represents a background portion, and the other bit “1” represents a latent portion. This latent/background region designation image 115 has a shape of a character string which emerges on a copy.

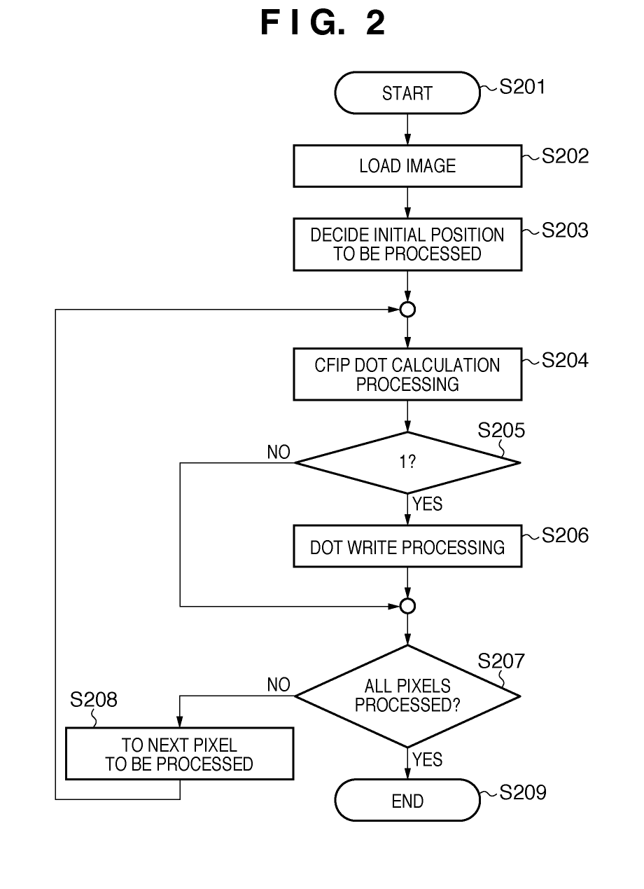

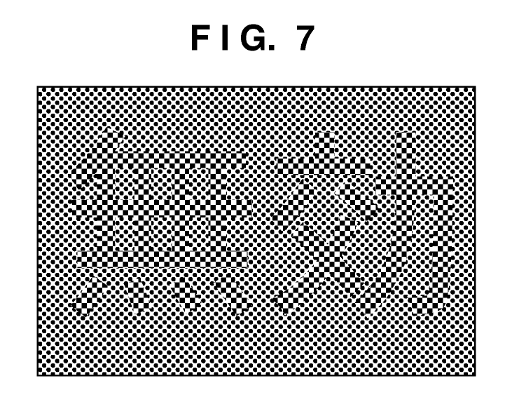

The CFIP image generation unit 101 pastes the latent threshold pattern 114 on the entire region designated as a latent region by the latent/background region designation image 115, and pastes the background threshold pattern 116 on the entire region designated as a background region. Thus, as shown in FIG. 7, a CFIP image in which concentrated dots are laid out on the latent portion and scattered dots are laid out on the background portion is generated. The processing contents of the CFIP image generation unit 101 will be described later with reference to FIG. 2. A CFIP image 117 generated by the CFIP image generation unit 101 is input to the composition unit 103.

An input document image 118 undergoes image processing including RGB-CMYK conversion, density correction processing (gamma correction processing), and halftoning in the input document data processing unit 102, and is then input to the composition unit 103.

Note that the density correction (gamma correction) processing is executed using density correction (gamma correction) parameters generated by the density correction (gamma correction) unit 106. A decision method of the density correction (gamma correction) parameters will be described later.

The composition unit 103 composites the input document image that has undergone the image processing in the input document data processing unit 102 and the CFIP image 117 generated by the CFIP image generation unit 101, thus generating a CFIP composite output image. Note that when the CFIP image 117 is used intact as a CFIP composite output image irrespective of the contents of the input document image 118, the composition unit 103 need not refer to the input document image 118.

The print data processing unit 104 receives the CFIP composite output image composited by the composition unit 103, and outputs it to the subsequent printing unit 105. At this time, the print data processing unit 104 stores the generation time of the CFIP composite output image and information associated with that image in the document management unit 108.

The printing unit 105 as an image forming unit prints out an output document composited with the CFIP image according to the information of the input CFIP composite output image data. Note that the printing unit 105 includes a printer engine which forms an image on an intermediate transfer member, and forms the formed image on the intermediate transfer member onto a sheet. Furthermore, this printing unit 105 can measure the density of an image on the intermediate transfer member, and can transmit the measurement result to the density correction unit 106.

Note that in the first embodiment, all of the CFIP image (CFIP image data), input document image (input document image data), and CFIP composite output image (CFIP composite output image data) indicate digital data. An image printed on a print medium such as a paper sheet will be explained in each case.

<Basic Operation of Apparatus>

FIG. 2 is a flowchart showing the operation of the CFIP image generation unit 101 of the printing apparatus according to the first embodiment. Note that the control unit which is not shown in FIG. 1 executes respective steps to be described below.

In step S201, the control unit starts CFIP image generation processing according to input information via a user interface or the like.

In step S202, the control unit loads the input background image 112, background threshold pattern 116, latent threshold pattern 114, and latent/background region designation image 115.

In step S203, the control unit decides an initial pixel upon generation of a CFIP image. For example, when image processing is applied to the entire input image in a raster scan order from an upper left pixel to a lower right pixel to change it to a CFIP image, the control unit sets the upper left pixel as an initial position.

In step S204, the control unit lays out the background threshold pattern 116, latent threshold pattern 114, and latent/background region designation image 115 in a tile pattern, respectively, from the upper left pixel of the input background image 112. Then, the control unit applies dot calculation processing to a pixel to be processed of the input background image 112 to determine whether or not a corresponding pixel value is written in a dot upon printing. At this time, a pixel value corresponds to input color information 111.

For example, the dot calculation processing is processed as follows.

(a) If a pixel corresponds to the latent portion in the latent/background region designation image 115 and has a black pixel value of the latent threshold pattern 114, “1” is set; if that pixel has a white pixel value, “0” is set.

(b) If a pixel corresponds to the background portion in the latent/background region designation image 115 and has a black pixel value of the background threshold pattern 116, “1” is set; if that pixel has a white pixel value, “0” is set.

In step S205, the control unit checks the calculation result in step S204. If the calculation result indicates “1”, the process advances to step S206; if it indicates “0”, the process jumps to step S207.

In step S206, the control unit executes processing for writing a corresponding pixel value in a dot upon printing. Note that the pixel value can be changed depending on the color of the CFIP image 117. If a black CFIP image is to be generated, the pixel to be processed of the input background image 112 is set to be black. In addition, by setting the pixel value to be cyan, magenta, or yellow in correspondence with a toner or ink color of the printer, a color CFIP image 117 can be generated.

The control unit checks in step S207 if processing for all pixels of the input background image 112 is complete. If the processing for all pixels of the input background image 112 is not complete yet, the process advances to step S208 to select a next pixel to be processed and to repeat the processes in steps S204 to S206. On the other hand, if the processing for all pixels of the input background image 112 is complete, the process advances to step S209 to end the image processing in the CFIP image generation unit 101. With the aforementioned processing, the CFIP image 117 is generated.

<Density Adjustment of CFIP Image (CFIP Density Adjustment Processing)>

As has been explained in the paragraphs of the related arts and problems, when a CFIP image is actually output using a printer, the latent and background portions are not always output to have intended densities due to various causes. The various causes include aging of an engine (degradations of a photosensitive drum and laser output unit), a print environment including humidity and temperature, ink or toner states of the printer, and the like. That is, optimal density values of the latent and background portions with respect to the dither matrixes vary depending on the types of printers, dither matrices, individual printers, print environments, and ink or toner.

Therefore, even when the engine characteristics of the printer and print environment are different, a CFIP image has to be generated after the latent and background threshold patterns corresponding to nearly equal reflection densities are obtained when they are printed. For this purpose, before execution of CFIP composition printing, processing for obtaining latent and background threshold patterns corresponding to nearly equal reflection densities of the latent and background portions, that is, CFIP density adjustment, is required to be executed for each printer.

As the CFIP density adjustment method, patent reference 2 discloses a method of adjusting the reflection densities on a sheet to be nearly equal to each other by changing a tone of a density value for one or both of the latent and background dither matrices. The technique of this patent reference 2 will be briefly explained below.

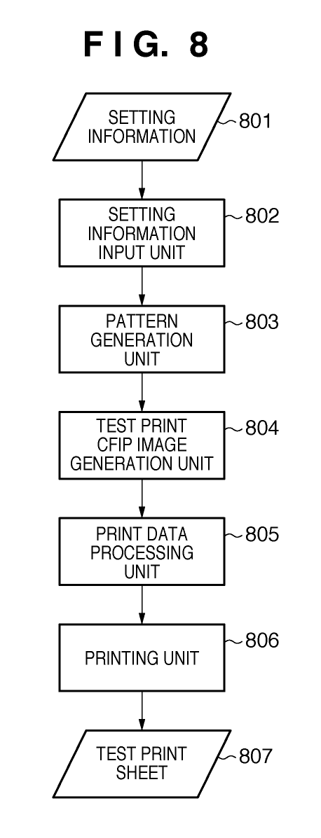

FIG. 8 is a block diagram showing the arrangement for executing CFIP density test printing required to attain density adjustment of a CFIP image. As shown in FIG. 8, the arrangement for executing the CFIP density test printing includes a setting information input unit 802, pattern generation unit 803, test print CFIP image generation unit 804, print data processing unit 805, and printing unit 806.

The setting information input unit 802 executes processing for reading setting information 801 from an initial setting file that saves the setting information 801. Alternatively, the setting information input unit 802 executes processing for receiving the setting information 801 input via a user interface. The pattern generation unit 803 generates threshold patterns (latent and background threshold patterns) required to generate a CFIP image, based on the setting information 801 input from the setting information input unit 802, and outputs the generated threshold patterns to the subsequent test print CFIP image generation unit 804. In the first embodiment, patterns generated based on the input setting information 801 include latent and background threshold patterns. In the CFIP density test print processing, the pattern generation unit 803 generates a plurality of latent and background threshold patterns. The test print CFIP image generation unit 804 generates test print CFIP images based on the patterns input from the pattern generation unit 803. Details of the test print CFIP images generated by this test print CFIP image generation unit 804 will be described later.

The print data processing unit 805 executes required image processing for the test print CFIP images generated by the test print CFIP image generation unit 804. Note that the print data processing unit 805 applies image processing to the test print CFIP images so as to prevent mixed colors of a plurality of inks or toners upon printing with respect to pixel values (cyan, magenta, yellow, and black) of the CFIP image. The test print CFIP images that have undergone the required image processing are sent to the printing unit 806. Then, the printing unit 806 prints out the test print CFIP images according to the input data.

A test print sheet on which a plurality of CFIP images (patches), which are generated by the test print CFIP image generation unit 804, and in each of which the densities of both the latent and background portions are changed, are two-dimensionally laid out, will be described below. On the test print sheet obtained by two-dimensionally changing the densities of the latent and background portions, patches are printed within a range from a low density to a high density, and one sheet includes a plurality of patches having nearly equal densities of the latent and background portions. Therefore, the densities of the CFIP images can also be provided to the user as selectable input values.

Since the test print sheet on which patches are two-dimensionally laid out by changing the densities of both the latent and background portions within one sheet is used, the user can specify a patch in which the latent portion has a preferred density, and the densities of the latent and background portions are nearly equal to each other. That is, the user can promptly specify CFIP density parameters (latent and background threshold patterns) required to generate a CFIP image on which a latent image clearly appears at the time of copying. The test print sheet on which patches are two-dimensionally laid out by changing the densities of both the latent and background portion can provide many pieces of information per sheet, and has excellent viewability and high convenience. Also, since the number of test print sheets to be output when the user searches for an optimal CFIP density can be reduced, an effect that leads to a paper cost reduction can be obtained.

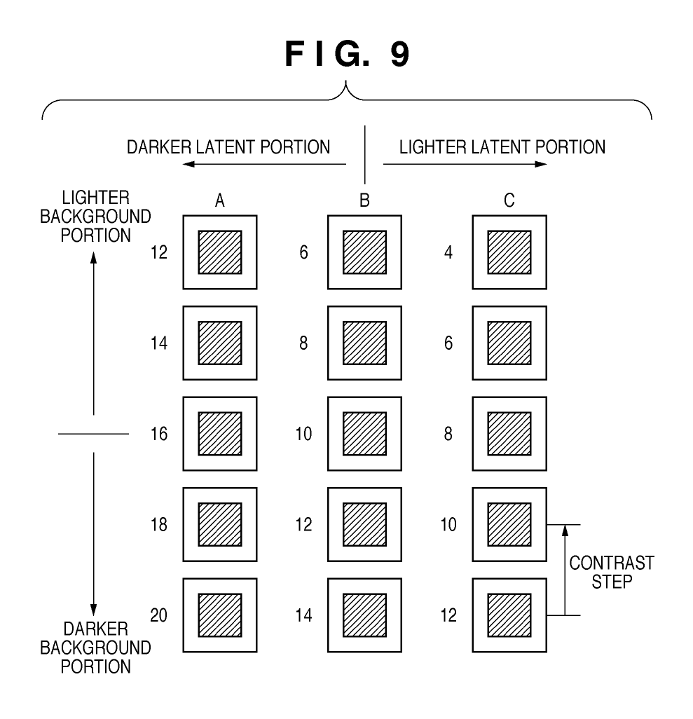

FIG. 9 is a view showing an example of a test print sheet on which patches in which the densities of the latent and background portions are changed are two-dimensionally laid out. Each patch surely includes the latent and background portions, and may also include camouflage. In each patch shown in FIG. 9, a central portion indicates the latent portion, and a peripheral portion indicates the background portion. In the example shown in FIG. 9, the latent/background region designation image used to designate the latent and background portions is represented by a square.

On the test print sheet shown in FIG. 9, the density of the latent portion (a density value to be added to the latent dither matrix) is changed in the widthwise direction of a sheet, and the density of the background portion (a density value to be added to the background dither matrix) is changed in the lengthwise direction.

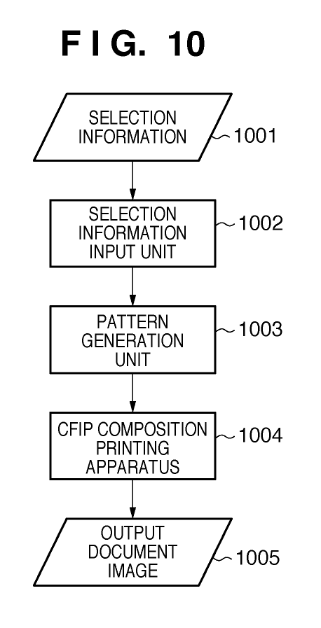

FIG. 10 is a block diagram showing the arrangement for executing a CFIP density adjustment function. In this arrangement, a selection information input unit 1002 and pattern generation unit 1003 are arranged before the printing apparatus shown in FIG. 1 (an apparatus 1004 in FIG. 10).

Referring to FIG. 10, the selection information input unit 1002 inputs information (for example, a number printed in the vicinity of a patch) associated with an optimal patch on the test print sheet determined by the user as selection information 1001 via a user interface. Note that the optimal CFIP image patch has, for example, a density the user wants, and is a patch in which the latent and background portions have nearly equal densities, and the latent portion remains and the background portion disappears when the test print sheet is copied by a target copying machine.

The pattern generation unit 1003 generates patterns required to generate a CFIP image (latent and background threshold patterns) based on the selection information 1001 input from the selection information input unit 1002, and inputs them to the printing apparatus 1004.

The printing apparatus 1004 generates a CFIP image based on the background and latent threshold patterns input from the pattern generation unit 1003, composites the CFIP image with an input document image, and prints out an output document. Since the processing in the printing apparatus 1004 has already been described in detail, a description thereof will not be repeated. As described above, in the printing apparatus according to the first embodiment of the present invention, the selection information input unit 1002 and pattern generation unit 1003 are added to the printing apparatus shown in FIG. 1 so as to allow the CFIP density adjustment. More specifically, the printing apparatus according to the first embodiment of the present invention includes a user interface, and a processing unit which has a CPU and the like, and executes processing based on input information via the user interface.

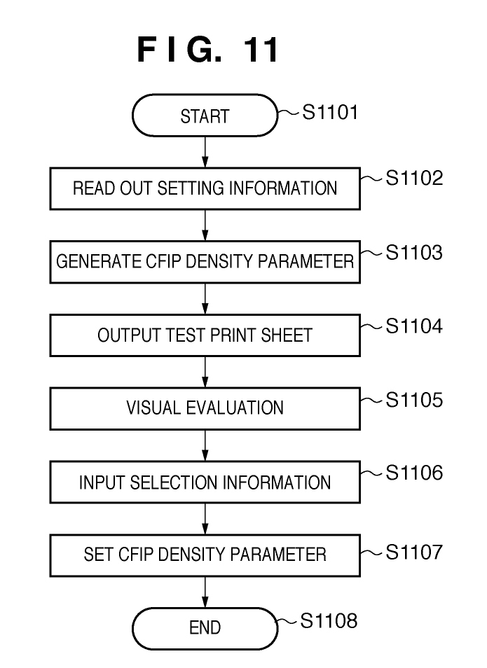

FIG. 11 is a flowchart showing the sequence of simplest test printing and CFIP density parameter settings based on a test print sheet. Note that a control unit which is not shown in FIG. 10 executes respective steps except for step S1105.

In step S1101, the control unit starts test printing in response to an input from the user via, for example, a user interface.

In step S1102, the control unit executes processing for reading setting information from an initial setting file that saves the setting information. Alternatively, the control unit executes processing for receiving the setting information input via a user interface.

In step S1103, the control unit generates CFIP density parameters so as to decide the print densities of the latent and background portions upon generation of a CFIP image, based on the setting information input in step S1102. In the first embodiment, CFIP density patterns generated based on the input setting information include background and latent threshold patterns.

In step S1104, the control unit generates a test print sheet shown in FIG. 9, based on the CFIP density parameters generated in step S1103, and prints it out using the printer.

In step S1105, the user visually compares the densities of the latent and background portions on respective patches on the test print sheet. Note that the processing in this step is generally executed by the user. However, image data read by an image reading apparatus such as a scanner may be evaluated.

The user's visual evaluation selects, from the test print sheet, a patch in which the reflection densities of the latent and background portions are nearly equal to each other, and the latent portion remains and the background portion disappears when the test print sheet is copied by a target copying machine. More specifically, the user selects a number associated with an optimal patch. For example, in the example shown in FIG. 9, patches in which the density of the latent portion is changed are arranged as A, B, and C columns in the widthwise direction of a sheet. Also, patches in which the density of the background portion is changed are arranged in the lengthwise direction of the sheet. Furthermore, a value indicating the density of the background portion is described beside each patch. Assume that a patch having a preferred density as a CFIP image is included. Also, assume that the density of the latent portion of that patch is expressed by “A column” and that of the background portion is expressed by “16”. In this case, the user selects that patch as “A-16”, and inputs that information in step S1106 below.

In step S1106, the control unit receives the number (for example, A-16) which is associated with the patch selected in step S1105 and is input from the user via, e.g., a user interface as selection information. The input selection information is held in the CFIP image generation unit 101 or is stored in the document management unit 108 of the printing apparatus or the like. At this time, a date and time at that time are also stored together in addition to the selection information.

In step S1107, the control unit sets the CFIP density parameters used to decide the print densities of the latent and background portions of a CFIP image based on the information input in step S1106. More specifically, the CFIP density parameters are set as latent and background threshold patterns with which the densities of the latent and background portions are nearly equal to each other, and the background portion disappears upon copying.

<Density Correction of Document Image>

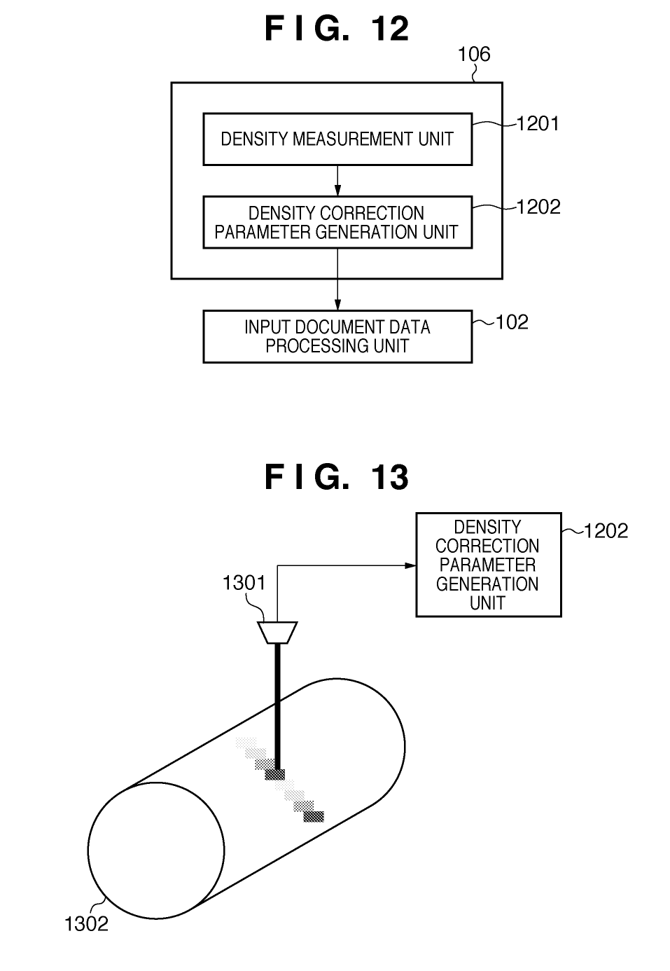

The density correction (gamma correction) unit 106 (FIG. 1), which corrects an input document image, will be described below with reference to FIGS. 12 to 16. Note that this density correction is to correct the density of a document image, and is different from the aforementioned density adjustment of the CFIP image.

FIG. 12 is a block diagram showing the detailed arrangement of the density correction (gamma correction) unit 106. Referring to FIG. 12, a density measurement unit 1201 measures reflection densities of a plurality of patches. A density correction (gamma correction) parameter generation unit 1202 generates, based on the measured reflection density values, new conversion parameters (gamma correction parameters) used to correct density tones so as to attain desired density characteristics. The density correction parameter generation unit 1202 sends the generated new density correction parameters (gamma correction parameters) to the document data processing unit 102.

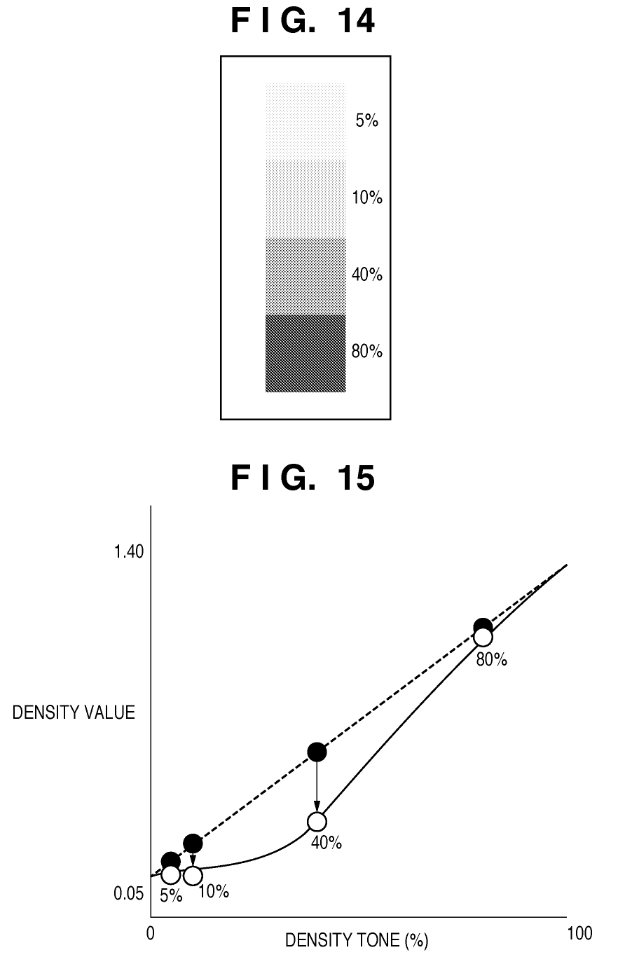

FIG. 13 is a diagram showing the arrangement of the density measurement unit 1201. Referring to FIG. 13, data of patches corresponding to tone values of 5%, 10%, 40%, and 80% (FIG. 14) are formed for C, M, Y, and K colors on an intermediate transfer member 1302 which forms a developing unit of the printing unit 105 in FIG. 1, and their reflection densities are measured by a sensor 1301. The measured reflection density values are then sent to the density correction parameter generation unit 1202. The processing of this density measurement unit 1201 is automatically executed at predetermined timings such as a prescribed print count or time, an environmental change, and parts exchange of printing apparatus. That is, this processing is automatically executed to compensate for changes of image formation densities.

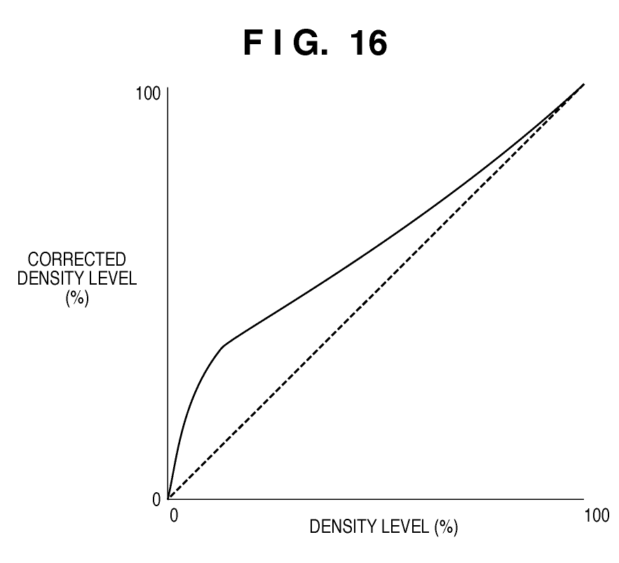

The density correction parameter generation method in the density correction parameter generation unit 1202 will be described below. FIG. 15 is a graph showing an example of the printer density characteristics. When the measured density values of the patches of 5%, 10%, 40%, and 80%, which are measured by the density measurement unit 1201, are respectively reflection density values indicated by o (white points) in FIG. 15, the density characteristics of the printer at that time are represented by the solid curve. The broken line represents desired ideal density characteristics (linear characteristics). When the density correction parameters are generated to attain the ideal density characteristics (the broken line in FIG. 15), the correction characteristics are represented by the solid curve in FIG. 16.

The document data processing unit 102 corrects (converts) the tone values of an input document image after being converted into CMYK data using the density correction (gamma correction) parameters generated by the density correction parameter generation unit 1202. Then, variations of color appearances of an output document to be printed and the like are suppressed.

<Density Adjustment Processing to Compensate For Density Variation of Printer Unit>

As described above, upon detection of occurrence of density variations of the printing unit 105, the density values of respective pixels of an input document image are corrected using new gamma correction parameters generated by the density correction unit 106. With this density value arrangement, an input document image is formed on a sheet as expected even when the density variations of the printing unit 105 have occurred.

This gamma correction does not correct the density of the CFIP image 117. This is because the density correction unit 106 is a processing unit which exchanges data with the document data processing unit 102, but which does not exchange any data with the CFIP image generation unit 101. For this reason, when the density variations of the printing unit 105 have occurred, the CFIP image is directly influenced by the density variations of the printing unit 105. In this case, the reflection densities of the latent and background portions have a difference, and the CFIP image is far from an original CFIP image.

That is, when the CFIP composite output image, which is stored in the storage unit 107 shown in FIG. 1, and is processed by the print data processing unit 104, is output from the printing unit according to an instruction from the control unit (not shown), that image largely suffers the influence of the density variations depending on its output timing. In particular, when a certain time has elapsed since the CFIP composite output image was generated and stored, the state of the printing unit has changed considerably, and the reflection densities of the latent and background portions of the CFIP image, which is appended to the output document image 119 output from the printing unit 105, have a difference.

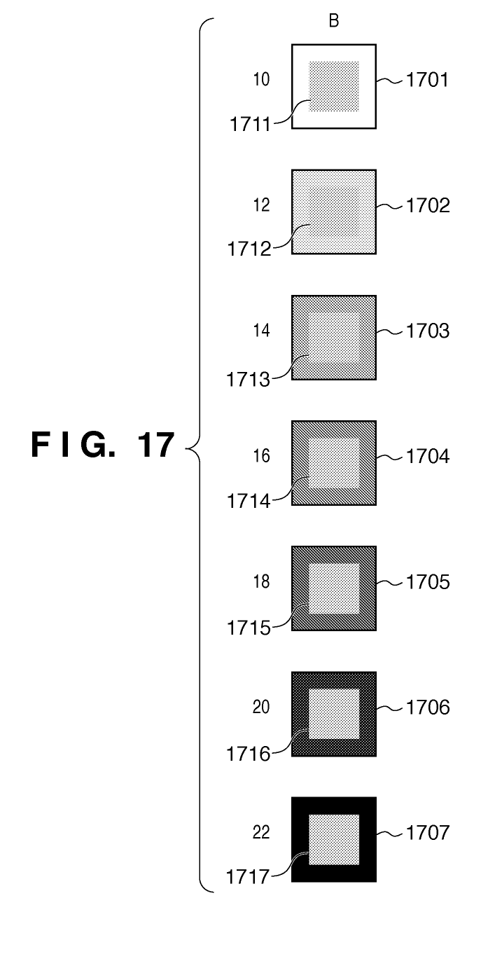

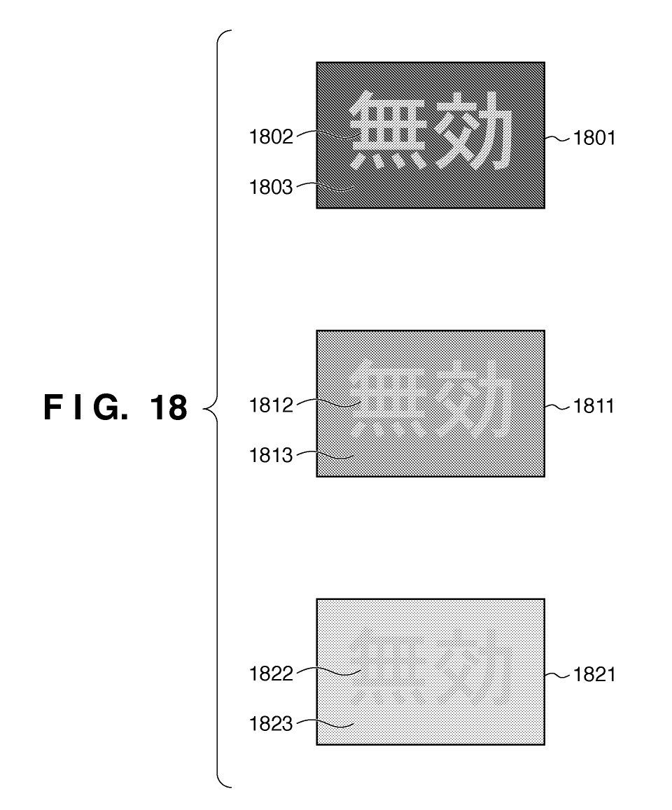

For example, upon adjustment by the aforementioned CFIP density adjustment method, assume that the user selects “B-16”, in which a background portion 1704 and latent portion 1714 have a small apparent reflection density difference, as a CFIP density adjustment result from a test print sheet shown in FIG. 17 (excerpts from FIG. 9). Reference numeral 1801 in FIG. 18 denotes a CFIP composite output image which is generated based on this adjustment result. A character portion including “invalid” corresponds to a latent portion 1802, and a background of the character portion corresponds to a background portion 1803. An output document image 1811 is obtained by printing the CFIP composite output image 1801 on a sheet. At this time, since a latent portion 1812 and background portion 1813 have equal apparent reflection densities, a character string “invalid” does not emerge. When this output document image 1811 is copied by a target copying machine, the background portion clearly disappears as a background portion 1823, and the character string “invalid” as a latent portion 1822 is clearly visualized.

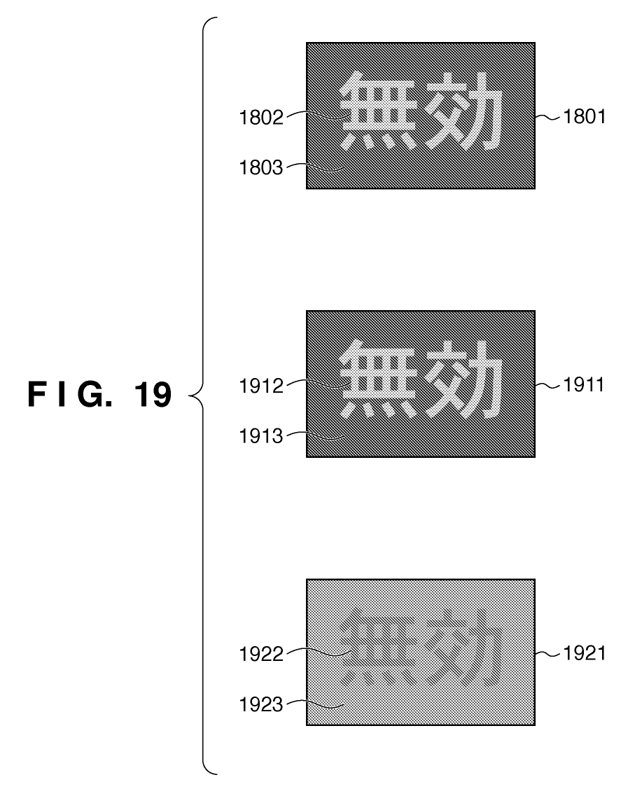

On the other hand, FIG. 19 shows an output document image which is obtained in such a manner that the CFIP composite output image generated at that time was stored in the storage unit 107 and is output again one month later. An output document image 1911 is obtained by printing the CFIP composite output image 1801 onto a sheet. At this time, the reflection density of a latent portion 1912 becomes high, and the latent portion 1912 and a background portion 1913 have an apparent reflection density difference. On the output document image 1911, a character string “invalid” emerges. When this output document image 1911 is copied by a target copying machine, a background portion 1923 does not disappear, and the character string “invalid” as a latent portion 1922 is not clearly visualized. That is, original characteristics of a CFIP image, in that an output document image includes a latent image, and that latent image is visualized on a copied document image, are lost, and the psychological deterrent force against copying of the CFIP image is lost.

Hence, processing for automatically executing CFIP image density adjustment with respect to the density variations of the printer unit (printing unit 105) according to the first embodiment will be described below. A case will be explained below wherein a CFIP composite output image stored in the storage unit 107 of the printing apparatus shown in FIG. 1 is to be output. Assume that a certain time has elapsed since the CFIP composite output image was generated until it is printed, and the state of the printing unit of the printing apparatus has varied. More specifically, assume that the density correction unit 106 executed the density correction of the printing unit within the elapsed time period. Also, assume that the CFIP image generation unit 101 also has executed CFIP density correction parallel to the former correction. As a result, the density characteristics of a printout at the generation timing of the CFIP composite output image have a large difference from those at its output timing.

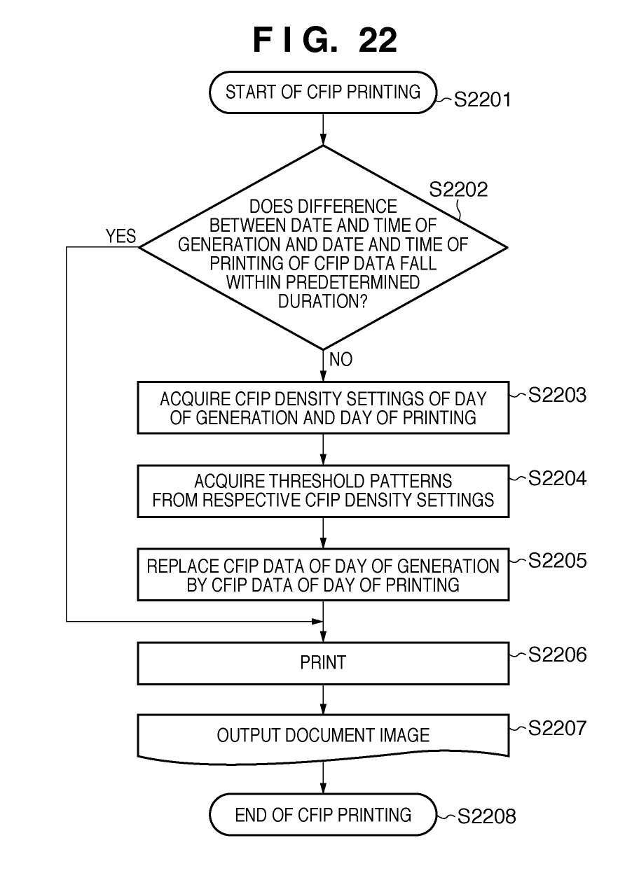

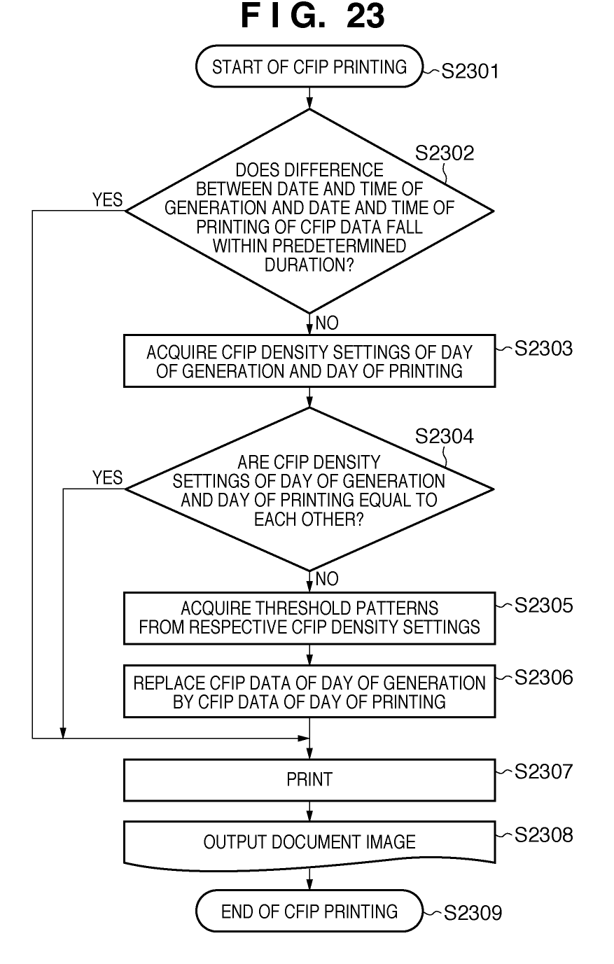

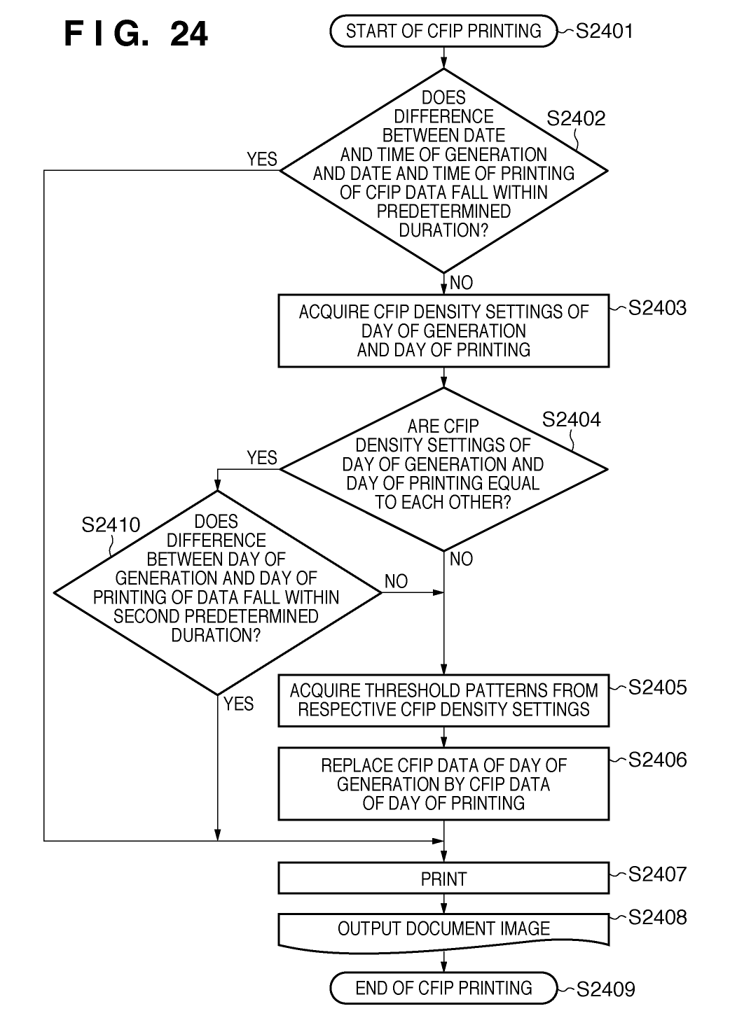

FIG. 22 is a flowchart showing the sequence for automatically carrying out density adjustment when a CFIP image is output. Note that the control unit which is not shown in FIG. 1 executes respective steps to be described below.

In step S2201, the control unit starts CFIP printing in response to an input from, for example, a user interface.

The control unit compares in step S2202 if a difference between the date and time of generation of the CFIP composite output image stored in the document management unit 108 and the date and time of print start falls within the number of days, which is set in advance. Note that information of the generation timing of the CFIP composite output image may be controlled to be stored in the document management unit 108 or may be controlled to be stored in the CFIP image generation unit 101. Alternatively, that information may be held in the storage unit 107 which stores the CFIP composite output image. In any case, the CFIP composite output image need only be associated with information of its generation timing. Note that the information of the generation timing includes a date and time (time information) of execution of the CFIP density adjustment and CFIP density adjustment values in addition to the date and time of generation (time information).

The control unit which is not shown in FIG. 1 decides a processing route based on the comparison result in step S2202. If the comparison result in step S2202 is Yes, the process jumps to print processing in step S2206. If the comparison result in step S2202 is No, the process advances to step S2203.

In step S2203, the control unit acquires CFIP density settings at the generation timing and the print timing (i.e., the current timing) of the CFIP composite output image. At this time, it is desirable to acquire the CFIP density setting values of both the latent and background portions of the CFIP image, but the setting values of only the background portions which suffer a large variation may be acquired.

In step S2204, the control unit acquires latent and background threshold patterns of both the generation and print timings based on the acquired CFIP density setting values of the generation and print timings.

In step S2205, the control unit executes density correction for the CFIP image of the CFIP composite output image based on the CFIP density setting values acquired in step S2203 and the threshold patterns acquired in step S2204. Details of this density correction method will be described later.

In step S2206, the control unit prints the CFIP composite output image including the density-corrected CFIP image. As a result, a density-corrected output document image is obtained in step S2207. In step S2208, the control unit ends the CFIP print processing.

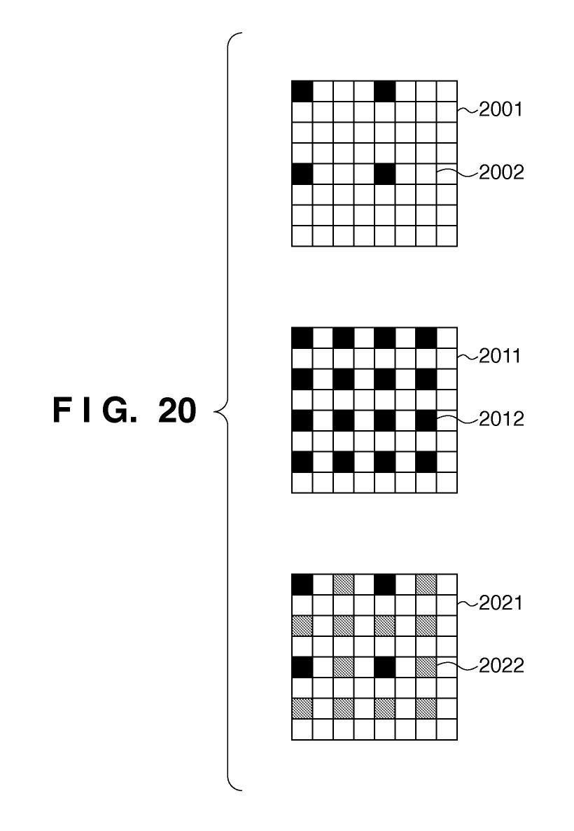

The CFIP image density correction in step S2205 will be described in detail below. For example, if a CFIP image, which was generated in a state having a CFIP density adjustment value “14” of a background portion (FIG. 17), is available, its background threshold pattern corresponds to a pattern 2011 in FIG. 20. When a CFIP composite output image generated in this state was stored in the storage unit 107 for a long period, and is then printed from the printing unit 105, since the density state of the printing unit has changed due to changes over time, the output document image 119 having the same quality as that at the generation timing cannot be obtained.

For example, the output document image 1911 including the background portion having a raised density is obtained, as shown in FIG. 19. When the output document image 1911 including this CFIP image is copied by a target copying machine, a copied document 1921 in which the background portion does not disappear, and the latent portion is not sufficiently visualized is obtained. This document does not sufficiently provide the CFIP function. For this reason, this problem is solved by applying the density correction to the CFIP image of the CFIP composite output image before printing from the printing unit 105.

According to the flowchart shown in FIG. 22, the CFIP setting value at the generation timing of the CFIP composite output image, and that at the print timing are acquired. In this case, assume that the CFIP density adjustment value of the background portion at the generation timing is “14” (FIG. 17), and that of the background portion at the print timing is “10” (FIG. 17). Background threshold patterns corresponding to these values are the pattern 2011 in FIG. 20 at the generation timing and a pattern 2001 in FIG. 20 at the print timing, respectively. Note that in each background threshold pattern in FIG. 20, four dot-distributed dither matrices of 4 pixels×4 pixels are arranged. In FIG. 20, the density of the background portion of the CFIP image at the print timing is raised compared to the generation timing. That is, the density of the background portion of the CFIP image at the print timing is required to be appropriately decreased.

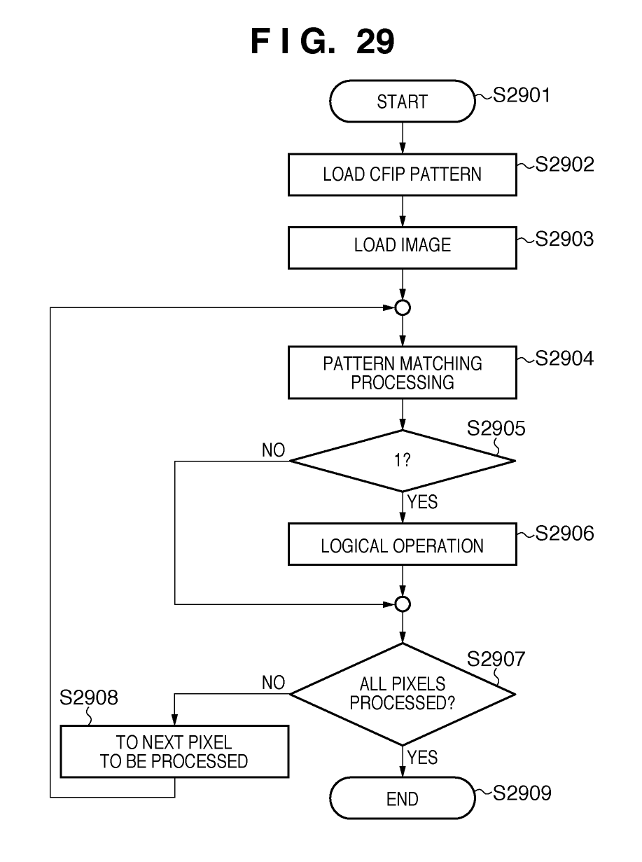

More specifically, the CFIP density adjustment values at the generation and print timings are referred to, and the background threshold pattern at the generation timing is replaced by that at the print timing, thus appropriately decreasing the density of the background portion. However, since the background threshold pattern has already been composited to an image, it cannot be simply replaced. Then, as shown in FIG. 29, the CFIP composite output image undergoes matching using the threshold pattern at the print timing to detect the composited background threshold pattern, and a logical operation between the CFIP composite output image and threshold pattern at the print timing can be made at that position for each unit of 4 pixels×4 pixels. The flowchart of FIG. 29 will be briefly described below. Note that since the CFIP density adjustment value and background threshold pattern are associated in advance with each other, a corresponding background threshold pattern can be selected based on the CFIP density adjustment value without generating a new background threshold pattern.

In step S2901, the control unit starts the CFIP data replacement processing in step S2205 in FIG. 22.

In step S2902, the control unit loads the threshold pattern used at the time of generation of the loaded CFIP composite output image. In step S2903, the control unit loads the CFIP composite output image.

In step S2904, the control unit applies pattern matching to the CFIP composite output image loaded in step S2902 using the threshold pattern loaded in step S2903. If the pattern hits, the control unit outputs “1”; otherwise, it outputs “0”.

In step S2905, the control unit checks the pattern matching result in step S2904. If the result is “1”, the process advances to step S2906; if it is “0”, the process jumps to step S2907.

In step S2906, the control unit executes a logical operation with respect to the CFIP composite output image using the threshold pattern at the print timing for each unit of 4 pixels×4 pixels described above.

The control unit checks in step S2907 if processing for all pixels of the CFIP composite output image is complete. If the processing for all pixels of the CFIP composite output image is not complete yet, the process advances to step S2908 to select a next pixel to be processed and to then execute the processes in steps S2904 to S2906 again. If the processing for all pixels of the CFIP composite output image is complete, the process advances to step S2909, thus ending the CFIP data replacement processing in step S2205.

Note that when the print characteristics of the printer have varied due to an elapse of time from the generation timing of a CFIP image until the print timing, and the density of the background portion of the CFIP image is unwantedly raised, the CFIP image has to be printed by decreasing the background density. That is, as can be seen from the above description, the background threshold pattern used at the generation timing of the CFIP image can be replaced by that which is reproduced to have a lower density than the former threshold pattern. For this purpose, when the background density at the print timing is set to be lower than that at the generation timing, a logical product between the CFIP composite output image and the background threshold pattern at the print timing can be calculated. Conversely, when the background density at the print timing is set to be higher than that at the generation timing, a logical sum between the CFIP composite output image and the background threshold pattern at the print timing can be calculated. Note that whether to increase the density (logical product) or to decrease the density (logical sum) is decided with reference to the CFIP density adjustment values at the generation timing of the CFIP image and at the print timing, as described above. In this case, when the CFIP density adjustment value is decreased, a lower background density is set. Conversely, when the CFIP density adjustment value is increased, a higher background density is set. For this reason, an increase/decrease in density can be controlled accordingly.

FIG. 20 is a view for explaining a practical example of the CFIP (background portion) density adjustment. The background threshold pattern at the generation timing of a target CFIP composite output image is a pattern 2011, and that at the print timing of the CFIP composite output image is a pattern 2001. In FIG. 20, a black pixel is a pixel where a background dot is printed, and a white pixel is a pixel where no background dot is printed. A logical operation is executed to have “1” as the black pixel where the background dot is printed, and “0” as the white pixel where no background dot is printed. When the density is to be decreased, a logical product between the background threshold pattern at the generation timing and that at the print timing is calculated. In this case, a background dot of each gray portion 2022 in a pattern 2021 is erased. In the above description, the logical product between the background threshold pattern at the generation timing and that at the print timing are calculated for the sake of simplicity. However, in practice, since the background threshold pattern at the generation timing has already been composited to the CFIP composite output image, the logical product between the CFIP composite output image and the background threshold pattern at the print timing is calculated.

Conversely, when the background threshold pattern at the generation timing is the pattern 2001 and that at the print timing is the pattern 2011, a logical sum between the background threshold pattern at the generation timing and that at the print timing is calculated so as to increase the density to be adjusted to that at the print timing. In this case, a background dot of each gray portion 2022 in the pattern 2021 is added to the background threshold pattern 2001 at the generation timing. In this case as well, in practice, since the background threshold pattern at the generation timing has already been composited to the CFIP composite output image, the logical sum between the CFIP composite output image and the background threshold pattern at the print timing is calculated.

As described above, the CFIP density can be increased at the print timing by calculating the logical sum between the CFIP composite output image and the background threshold pattern at the print timing. Conversely, the CFIP density can be decreased at the print timing by calculating the logical product between the CFIP composite output image and the background threshold pattern at the print timing.

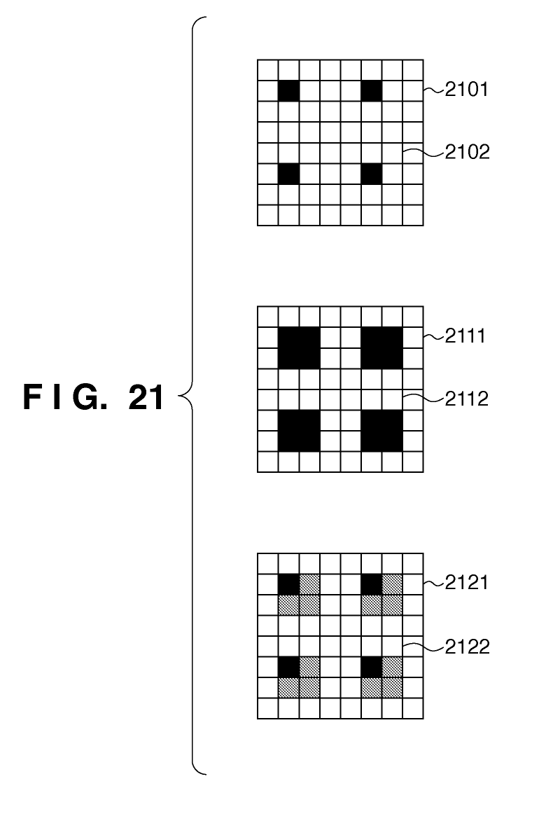

Note that the background portion has been described so far, and the density of the latent portion can also be adjusted by the same method. Since latent threshold patterns shown in FIG. 21 also include regularly arranged dots, their densities can be adjusted by the same method. When a latent threshold pattern at the generation timing is a pattern 2101 and that at the print timing is a pattern 2111, and when the density of the latent portion is to be increased at the print timing, a logical sum between the CFIP composite output image and the latent threshold pattern at the print timing is calculated, thereby increasing the CFIP density of the latent portion. Conversely, when the CFIP density of the latent portion is to be decreased at the print timing, a logical product between the CFIP composite output image and the latent threshold pattern at the print timing is calculated, thereby decreasing the CFIP density of the latent portion.

As described above, according to the printing apparatus of the first embodiment, the technique that allows printing out a CFIP composite image having an appropriate image density without losing any CFIP function by changing CFIP threshold patterns with reference to the CFIP density setting values at the generation and print timings can be provided. With this technique, even when a CFIP composite output image which was stored previously is output after an elapse of certain time, the influence of the print density variations of the image processing apparatus can be eliminated. Then, the psychological deterrent force of a CFIP image against copying due to visualization of a latent image upon copying an output matter can be prevented from being lost.

(First Modification)

The first modification will describe an example in which whether or not to execute CFIP density correction is decided with reference to CFIP density setting values of a date of generation and that of printing. FIG. 23 is a flowchart showing the sequence for executing density adjustment at the output timing of a CFIP image according to the first modification.

In step S2301, the control unit starts CFIP printing in response to an input from, for example, a user interface.

The control unit compares in step S2302 if a difference between the date and time of generation of the CFIP composite output image stored in the document management unit 108 and the date and time of print start falls within the number of days, which is set in advance. Note that information of the generation timing of the CFIP composite output image may be stored in the document management unit 108 or may be stored in the CFIP image generation unit 101. Alternatively, that information may be held in the storage unit 107 which stores the CFIP composite output image. In any case, the CFIP composite output image need only be associated with information of its generation timing. Note that the information of the generation timing includes a date and time of execution of the CFIP density adjustment and CFIP density adjustment values in addition to the date and time of generation. The control unit decides a processing route based on the comparison result in step S2302. If the comparison result in step S2302 is Yes, the process jumps to print processing in step S2307. If the comparison result in step S2302 is No, the process advances to step S2303.

In step S2303, the control unit acquires CFIP density settings at the generation and print timings of the CFIP composite output image. At this time, it is desirable to acquire the CFIP density setting values of both the latent and background portions of the CFIP image, but the setting values of only the background portions which suffer a large variation may be acquired.

The control unit compares in step S2304 if the density setting at the generation timing of the CFIP composite output image and that at the print timing are equal to each other. If the comparison result in step S2304 is Yes, the process jumps to the print processing in step S2307. If the comparison result in step S2304 is No, the process advances to step S2305.

In step S2305, the control unit acquires latent and background threshold patterns of both the generation and print timings based on the acquired CFIP density setting values of the generation and print timings.

In step S2306, the control unit executes density correction for the CFIP image of the CFIP composite output image based on the CFIP density setting values acquired in step S2303 and the threshold patterns acquired in step S2305. Details of this density correction method are the same as those described in the first embodiment, and a description thereof will not be repeated.

In step S2307, the control unit prints the CFIP composite output image including the density-corrected CFIP image. As a result, a density-corrected output document image is generated in step S2308. In step S2309, the control unit ends the CFIP print processing.

As described above, when the difference between the date and time of generation and those of printing of the CFIP composite output image including the CFIP image is larger than a predetermined duration, and the CFIP density setting value at the generation timing is different from that at the print timing, the CFIP threshold pattern is changed. As a result, the technique that allows printing out a CFIP composite image having an appropriate image density without losing any CFIP function can be provided as in the first embodiment.

(Second Modification)

The second modification will describe an example in which whether or not to execute CFIP density correction is decided also in consideration of the reliability of the CFIP density setting values. FIG. 24 is a flowchart showing the sequence for executing density adjustment at the output timing of a CFIP image according to the second modification.

In step S2401, the control unit starts CFIP printing in response to an input from, for example, a user interface.

The control unit compares in step S2402 if a difference between the date and time of generation of the CFIP composite output image stored in the document management unit 108 and the date and time of print start falls within the number of days, which is set in advance. At this time, information of the generation timing of the CFIP composite output image may be stored in the document management unit 108 or may be stored in the CFIP image generation unit 101. Alternatively, that information may be held in the storage unit 107 which stores the CFIP composite output image. In any case, the CFIP composite output image need only be associated with information of its generation timing. Note that the information of the generation timing includes a date and time of execution of the CFIP density adjustment and CFIP density adjustment values in addition to the date and time of generation. The control unit decides a processing route based on the comparison result in step S2402. If the comparison result in step S2402 is Yes, the process jumps to print processing in step S2407. If the comparison result in step S2402 is No, the process advances to step S2403.

In step S2403, the control unit acquires CFIP density settings at the generation and print timings of the CFIP composite output image. At this time, it is desirable to acquire the CFIP density setting values of both the latent and background portions of the CFIP image, but the setting values of only the background portions which suffer a large variation may be acquired.

The control unit compares in step S2404 if the density setting at the generation timing of the CFIP composite output image and that at the print timing are equal to each other. If the comparison result in step S2404 is No, the process advances to step S2405. If the comparison result in step S2404 is Yes, the process advances to step S2410.

The control unit compares in step S2410 if the difference between the date and time of generation and those of print start of the CFIP composite output image falls within the number of days, which is different from that in step S2402 and is set in advance. If the comparison result in step S2410 is Yes, the control unit determines that the reliability of the density setting values is high, and the process jumps to the print processing in step S2407. If the comparison result in step S2410 is No, the process advances to step S2405.

In step S2405, the control unit acquires latent and background threshold patterns of both the generation and print timings based on the acquired CFIP density setting values of the generation and print timings.

In step S2406, the control unit executes density correction for the CFIP image of the CFIP composite output image based on the CFIP density setting values acquired in step S2403 and the threshold patterns acquired in step S2405. Details of this density correction method are the same as those described in the first embodiment, and a description thereof will not be repeated.

In step S2407, the control unit prints the CFIP composite output image including the density-corrected CFIP image. As a result, a density-corrected output document image is generated in step S2408. After that, the control unit ends the CFIP print processing in step S2409.

As described above, the CFIP threshold pattern is changed in consideration of the reliability of the CFIP density setting values in addition to the judgment in the first modification. As a result, the technique that allows printing out a CFIP composite image having an appropriate image density without losing any CFIP function can be provided as in the first embodiment.

(Third Modification)

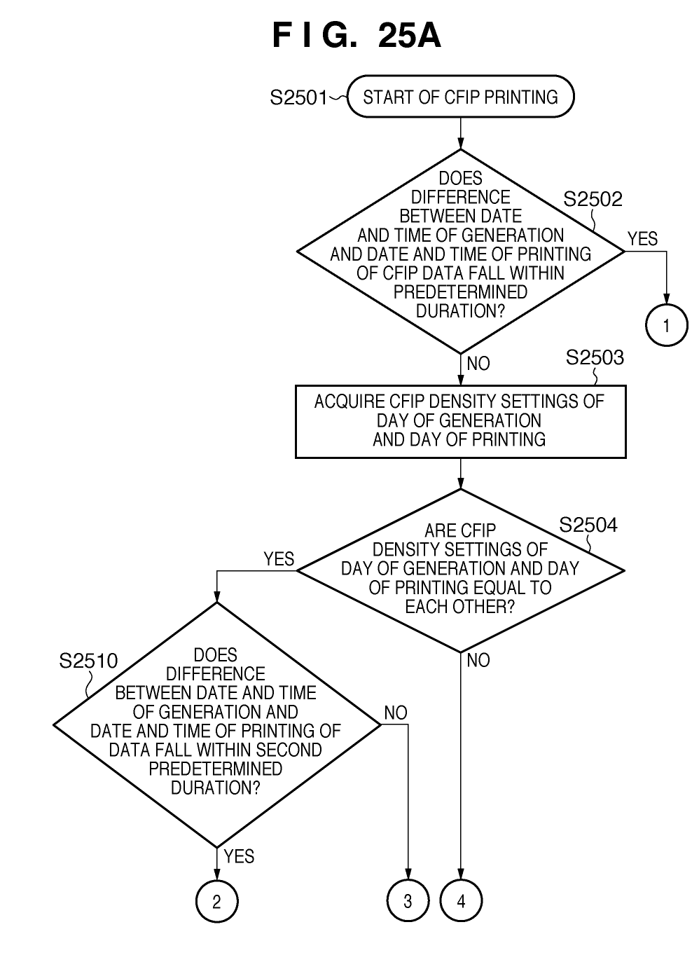

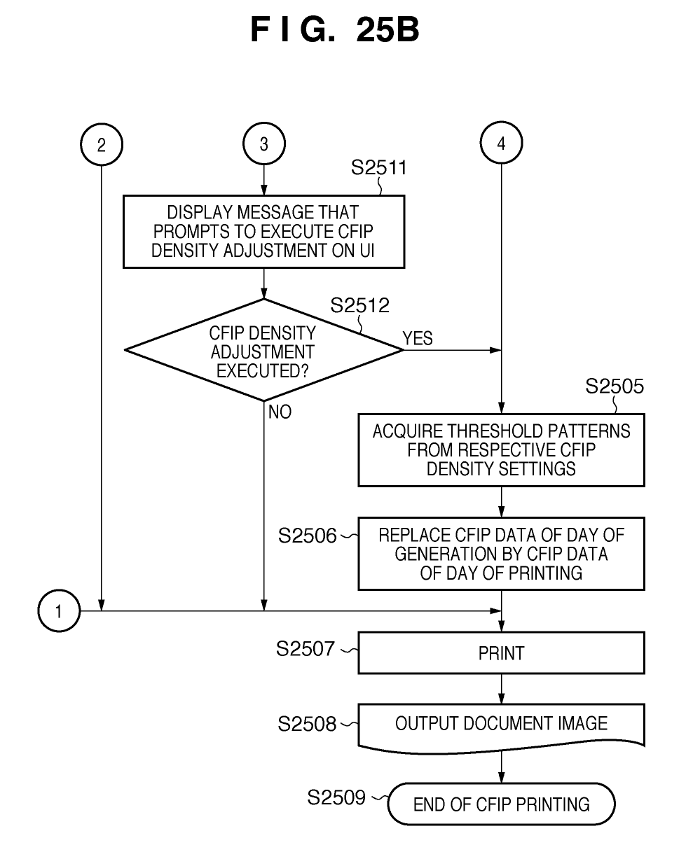

The third modification will describe an example in which a message that prompts the user to execute CFIP density adjustment is notified. FIGS. 25A and 25B are flowcharts showing the sequence for executing density adjustment at the output timing of a CFIP image according to the third modification.

In step S2501, the control unit starts CFIP printing in response to an input from, for example, a user interface.

The control unit compares in step S2502 if a difference between the date and time of generation of the CFIP composite output image stored in the document management unit 108 and the date and time of print start falls within the number of days, which is set in advance. At this time, information of the generation timing of the CFIP composite output image may be stored in the document management unit 108 or may be stored in the CFIP image generation unit 101. Alternatively, that information may be held in the storage unit 107 which stores the CFIP composite output image. In any case, the CFIP composite output image need only be associated with information of its generation timing. Note that the information of the generation timing includes a date and time of execution of the CFIP density adjustment and CFIP density adjustment values in addition to the date and time of generation. The control unit decides a processing route based on the comparison result in step S2502. If the comparison result in step S2502 is Yes, the process jumps to print processing in step S2507. If the comparison result in step S2502 is No, the process advances to step S2503.

In step S2503, the control unit acquires CFIP density settings at the generation and print timings of the CFIP composite output image. At this time, it is desirable to acquire the CFIP density setting values of both the latent and background portions of the CFIP image, but the setting values of only the background portions which suffer a large variation may be acquired.

The control unit compares in step S2504 if the density setting at the generation timing of the CFIP composite output image and that at the print timing are equal to each other. If the comparison result in step S2504 is No, the process advances to step S2505. If the comparison result in step S2504 is Yes, the process advances to step S2510.

The control unit compares in step S2510 if the difference between the date and time of generation and those of print start of the CFIP composite output image falls within the number of days, which is different from that in step S2502 and is set in advance. If the comparison result in step S2510 is Yes, the control unit determines that the reliability of the density setting values is high, and the process jumps to the print processing in step S2507. If the comparison result in step S2510 is No, the process advances to step S2511.

In step S2511, the control unit displays a message that prompts the user to execute CFIP density adjustment using a UI unit (display unit or the like; not shown) (inquiry unit).

In step S2512, the UI unit which receives an input from the user notifies the control unit of the result. If the result is No (if the CFIP density adjustment is to be skipped), the process jumps to the print processing in step S2507. On the other hand, if the result is Yes (if the CFIP density adjustment is to be executed), the process advances to step S2505.

In step S2505, the control unit acquires latent and background threshold patterns of both the generation and print timings based on the acquired CFIP density setting values of the generation and print timings.

In step S2506, the control unit executes density correction for the CFIP image of the CFIP composite output image based on the CFIP density setting values acquired in step S2503 and the threshold patterns acquired in step S2505. Details of this density correction method are the same as those described in the first embodiment.

In step S2507, the control unit prints the CFIP composite output image including the density-corrected CFIP image. As a result, a density-corrected output document image is generated in step S2508. After that, the control unit ends the CFIP print processing in step S2509.

As described above, since the final judgment as to whether or not to execute the CFIP density adjustment is received from the user in addition to the judgment in the second modification, the CFIP composite output image can be printed more preferably.

(Fourth Modification)

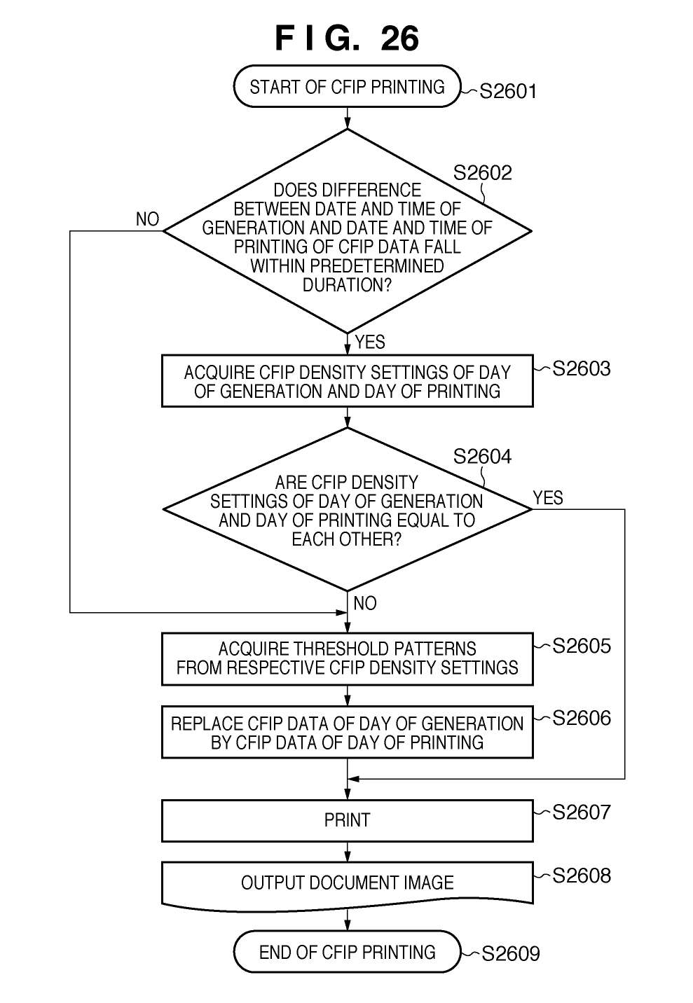

The fourth modification will describe an example in which the operation of the first modification is partially modified. FIG. 26 is a flowchart showing the sequence for executing density adjustment at the output timing of a CFIP image according to the fourth modification.

More specifically, the subsequent operation based on the determination result in step S2302 is different. Note that the operations of other steps are the same as those in the first modification, and a detailed description thereof will not be repeated.

If the comparison result in step S2602 (the same determination processing as in step S2302) is Yes, the process advances to step S2603 to acquire the CFIP density settings at the generation and print timings of the CFIP composite output image. On the other hand, if the comparison result is No, the process jumps to the threshold pattern acquisition processing in step S2605.

More specifically, according to the fourth modification, even when the difference between the date and time of generation and those of printing of the CFIP composite output image including the CFIP image is larger than a predetermined duration, if the CFIP density setting value at the generation timing is different from that at the print timing, the CFIP threshold pattern is changed. That is, the CFIP pattern is replaced based on the CFIP density setting as latest as possible. As a result, the printout result of the CFIP composite output image can be acquired more preferably.

### Second Embodiment

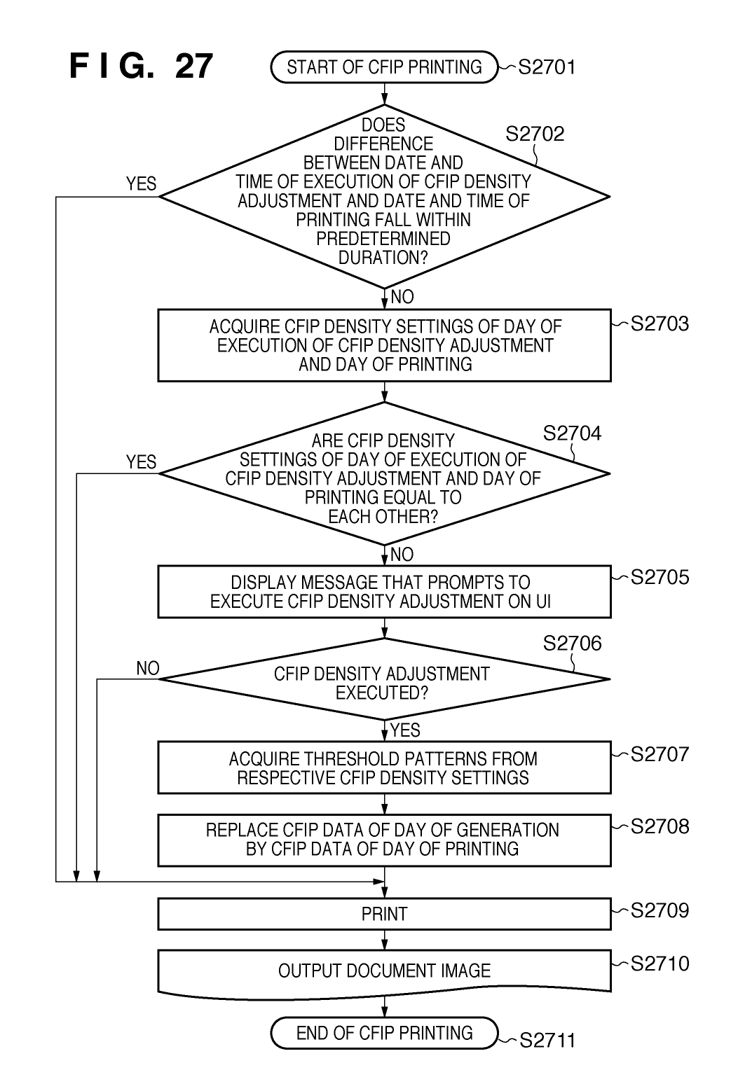

The second embodiment will describe an example in which whether or not to execute CFIP density correction is determined based on whether or not a difference between the date and time of CFIP adjustment and those of printing falls within a predetermined duration, and a user's execution necessity/unnecessity instruction. FIG. 27 is a flowchart showing the sequence for executing density adjustment at the output timing of a CFIP image according to the second embodiment.

In step S2701, a control unit starts CFIP printing in response to an input from, for example, a user interface.

The control unit compares in step S2702 if a difference between the date and time of execution of CFIP density adjustment stored in the document management unit 108 and the date and time of print start falls within the number of days, which is set in advance. At this time, information of the generation timing of the CFIP composite output image may be stored in the document management unit 108 or may be stored in the CFIP image generation unit 101. Alternatively, that information may be held in the storage unit 107 which stores the CFIP composite output image. In any case, the CFIP composite output image need only be associated with information of its generation timing. Note that the information of the generation timing includes a date and time of execution of the CFIP density adjustment and CFIP density adjustment values in addition to the date and time of generation. The control unit decides a processing route based on the comparison result in step S2702. If the comparison result in step S2702 is Yes, the process jumps to print processing in step S2709. If the comparison result in step S2702 is No, the process advances to step S2703.

In step S2703, the control unit acquires CFIP density settings of the CFIP composite output image at the execution timing of the CFIP density adjustment and the print timing. At this time, it is desirable to acquire the CFIP density setting values of both the latent and background portions of the CFIP image, but the setting values of only the background portions which suffer a large variation may be acquired.

The control unit compares in step S2704 if the density setting at the execution timing of the CFIP density adjustment and that at the print timing are equal to each other. If the comparison result in step S2704 is Yes, the process jumps to the print processing in step S2709. If the comparison result in step S2704 is No, the process advances to step S2705.

In step S2705, the control unit displays a message that prompts the user to execute CFIP density adjustment using a UI unit (display unit or the like; not shown).

In step S2706, the control unit confirms whether or not the CFIP density adjustment is executed. If that result is No, the process jumps to the print processing in step S2709. If the result is Yes, the process advances to step S2707.

In step S2707, the control unit acquires latent and background threshold patterns of both the generation and print timings based on the acquired CFIP density setting values of the generation and print timings.

In step S2708, the control unit executes density correction for the CFIP image of the CFIP composite output image based on the CFIP density setting values acquired in step S2703 and the threshold patterns acquired in step S2705. Details of this density correction method are the same as those described in the first embodiment.

In step S2709, the control unit prints the CFIP composite output image including the density-corrected CFIP image. As a result, a density-corrected output document image is generated in step S2710. After that, the control unit ends the CFIP print processing in step S2711.

As described above, according to the printing apparatus of the second embodiment, the CFIP threshold pattern is changed with reference to the CFIP density setting values at the generation and print timings based on the difference between the date and time of execution of the CFIP density adjustment and those of printing. With this processing, the technique that allows printing out a CFIP composite image having an appropriate image density without losing any CFIP function can be provided. Also, since the final judgment as to whether or not to execute the CFIP density adjustment is received from the user, a CFIP composite output image can be printed more preferably.

### Third Embodiment

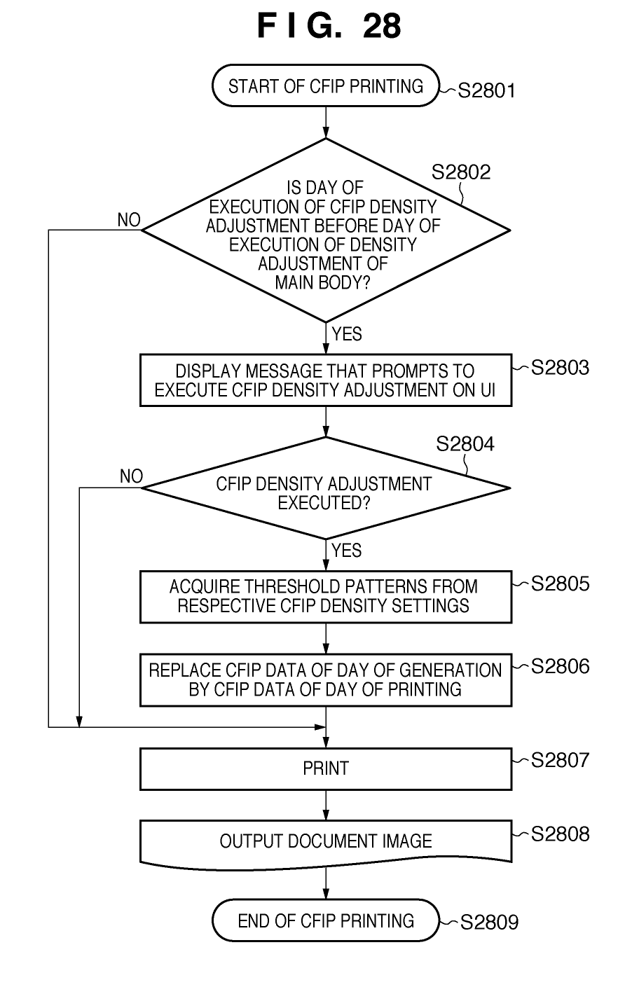

The third embodiment will describe an example in which whether or not to execute CFIP density correction is determined based on the presence/absence of execution of density adjustment of a printing apparatus, and that of execution of CFIP density adjustment. FIG. 28 is a flowchart showing the sequence for executing density adjustment at the output timing of a CFIP image according to the third embodiment.

In step S2801, a control unit starts CFIP printing in response to an input from, for example, a user interface.

The control unit compares in step S2802 if the date and time of execution of CFIP density adjustment stored in the document management unit 108 are before those of execution of density adjustment of the printing apparatus. At this time, information of the generation timing of the CFIP composite output image may be stored in the document management unit 108 or may be stored in the CFIP image generation unit 101. Alternatively, that information may be held in the storage unit 107 which stores the CFIP composite output image. In any case, the CFIP composite output image need only be associated with information of its generation timing. Note that the information of the generation timing includes a date and time of execution of the CFIP density adjustment and CFIP density adjustment values in addition to the date and time of generation. The control unit decides a processing route based on the comparison result in step S2802. If the comparison result in step S2802 is No, the process jumps to print processing in step S2807. If the comparison result in step S2802 is Yes, the process advances to step S2803.

In step S2803, the control unit displays a message that prompts the user to execute CFIP density adjustment using a UI unit (display unit or the like; not shown).

In step S2804, the control unit confirms whether or not the CFIP density adjustment is executed. If that result is No, the process jumps to the print processing in step S2807. If the result is Yes, the process advances to step S2805.

In step S2805, the control unit acquires latent and background threshold patterns of both the generation timing of CFIP print data and the latest CFIP density value based on the CFIP density setting value of the generation timing and the latest CFIP density setting value.

In step S2806, the control unit executes density correction for the CFIP image of the CFIP composite output image based on the CFIP density setting values acquired in step S2804 and the threshold patterns acquired in step S2805. Details of this density correction method are the same as those described in the first embodiment.

In step S2807, the control unit prints the CFIP composite output image including the density-corrected CFIP image. As a result, a density-corrected output document image is generated in step S2808. After that, the control unit ends the CFIP print processing in step S2809.

As described above, according to the printing apparatus of the third embodiment, the CFIP threshold pattern is changed with reference to the CFIP density setting values at the generation and print timings based on the presence/absence of execution of the density adjustment of the printing apparatus and that of execution of the CFIP density adjustment. With this processing, the technique that allows printing out a CFIP composite image having an appropriate image density without losing any CFIP function can be provided. Also, since the final judgment as to whether or not to execute the CFIP density adjustment is received from the user, a CFIP composite output image can be printed more preferably.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-280273, filed Oct. 30, 2008, which is hereby incorporated by reference herein in its entirety.

1. A printing apparatus comprising:
a storage unit which stores copy-forgery-inhibited pattern (CFIP) image data including a latent portion and a background portion;
a comparison unit which, when a printout instruction is issued for the CFIP image data stored in said storage unit, compares a CFIP density setting value at a time the CFIP image data was generated and a CFIP density setting value at a time the printout instruction was issued;
a replacement unit which, when said comparison unit determines that the CFIP density setting values are not equal to each other, replaces an image pattern of at least one of the latent portion and the background portion included in the CFIP image data with another image pattern having a different density; and
a control unit which controls an image forming unit to print out the CFIP image data in which the image pattern of at least one of the latent portion and the background portion is replaced.

2. The apparatus according to claim 1, wherein when the printout instruction of the CFIP image data stored in said storage unit is issued, said replacement unit replaces an image pattern corresponding to the CFIP density setting value at the time the CFIP image data was generated with an image pattern corresponding to the CFIP density setting value at the time the printout instruction was issued.

3. The apparatus according to claim 1, further comprising a determination unit which determines, based on time information when the CFIP image data was generated and time information when the CFIP image data is to be printed, whether or not an elapsed time since generation of the CFIP image data exceeds a predetermined elapsed time,
wherein said replacement unit performs the replacement when said determination unit determines that the elapsed time exceeds the predetermined elapsed time, and said comparison unit determines that the CFIP density setting values are not equal to each other.

4. The apparatus according to claim 3, further comprising:
a CFIP density adjustment unit which adjusts an image density of at least one of the latent portion and the background portion included in the CFIP image data so as to compensate for a change in image forming density in the image forming unit; and
an inquiry unit which inquires of the user as to whether or not to execute CFIP density adjustment processing by said CFIP density adjustment unit, when said determination unit determines that the elapsed time exceeds the predetermined elapsed time.

5. A method of controlling a printing apparatus, comprising the steps of:
storing, in a storage unit, copy-forgery-inhibited pattern (CFIP) image data including a latent portion and a background portion;
comparing, when a printout instruction is issued for the CFIP image data stored in the storage unit, a CFIP density setting value at a time the CFIP image data was generated and a CFIP density setting value at a time the printout instruction was issued;
replacing, when it is determined in said comparing step that the CFIP density setting values are not equal to each other, an image pattern of at least one of the latent portion and the background portion included in the CFIP image data with another image pattern having a different density; and
controlling an image forming unit to print out the CFIP image data in which the image pattern of at least one of the latent portion and the background portion is replaced.

6. A computer program stored in a computer-readable storage medium to make a computer function as respective units of a printing apparatus according to claim 1.
